(19) United States
(12) Patent Application Publication
(10) Pub. No.: US 2004/0083867 A1
(43) Pub. Date: May 6, 2004

(54) Method and apparatus for detachably securing tool attachments to a cultivator

(76) Inventors: Allen D. Elock, Glendon (CA); Paulette M. Elock, Glendon (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/601,052

(22) Filed: Jun. 20, 2003

(30) Foreign Application Priority Data
Mar. 28, 2002 (CA) 2,377,475

(51) Int. Cl. B26D 7/06

(52) U.S. Cl. 83/101

(57) ABSTRACT

An apparatus for detachably securing tool attachments to a cultivator, which includes a first portion and a second portion. The first portion has a planer body with a first and second face, a first and a second end. The first portion is secured to a surface of a tool attachment. The second portion has an elongate body having a first and second face, a first and a second end. An upper retaining member is provided at the first end, and a lower retaining member is provided at the second end. The second portion is secured a surface of a shank of a cultivator. Upon sliding engagement of the first portion with the second portion, the first end of the planer body is positioned between the upper retaining member and the first face, and the second end of the planer body is positioned between the lower retaining member and the first face of the second portion.

### FIELD OF THE INVENTION

The present invention relates to a method and apparatus for detachably securing tool attachments to cultivators.

### BACKGROUND OF THE INVENTION

Previously, farmers and construction contractors bolted tool attachments, such as a sweep, or a spike, to the shank of a cultivator. Removing bolts is very time consuming and injurious cuts to the hands have resulted. Many farmers cut the bolts off with a cutting torch rather than use an impact wrench. Buying bolts and nuts each time a change between tool attachments is required is an added cost.

### SUMMARY OF THE INVENTION

What is required is simpler and faster method of attaching and detaching tools attachments.

According to the present invention there is provided an apparatus for detachably securing tool attachments to a cultivator which includes a first portion and a second portion. The first portion has a planer body with a first face, a second face, a first end and a second end. Means are provided for securing the planer body to a surface of a tool attachment. The second portion has an elongate body with a first face, a second face, a first end, and a second end. An upper retaining member is provided at the first end, and a lower retaining member is provided at the second end. Means are provided for securing the second portion a surface of a shank of a cultivator. The upper retaining member is angled outward from the first face adjacent the first end and toward the second end and the lower retaining member is angled outward from the first face adjacent the second end and toward the first end, such that upon sliding engagement of the first portion with the second portion, the first end of the planer body is positioned between the upper retaining member and the first face, and the second end of the planer body is positioned between the lower retaining member and the first face of the second portion to detachably secure the tool attachment to the shank of a cultivator.

According to the present invention there is also provided method of detachably securing tool attachments to a cultivator, which includes the step of providing a tool attachment. A further step involves providing a cultivator with a shank. Another step involves providing an apparatus which has a first portion and a second portion. The first portion being a planer body has a first face, a second face, a first end and a second end. The second portion is an elongate body which has a first face, a second face, a first end, and a second end. An upper retaining member is provided at the first end, and a lower retaining member is provided at the second end. The upper retaining member is angled outward from the first face adjacent the first end and toward the second end. The lower retaining member is angled outward from the first face adjacent the second end and toward the first end.

A further step involves mounting the first portion to the tool attachment. Another step involves mounting the second portion to the shank of the cultivator. The final step involves slidably engaging the first portion with the second portion such that the first end of the planer body is positioned between the upper retaining member and the first face and the second end of the planer body is positioned between the lower retaining member and the first face of the second portion to detachably secure the tool attachment to the shank of a cultivator.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an exploded perspective view of an apparatus for detachably securing tool attachments to a cultivator constructed in accordance with the teachings of the invention;

FIG. 2 is a perspective view of a first portion of the apparatus illustrated in FIG. 1;

FIG. 3 is a perspective view of a second portion of the apparatus illustrated in FIG. 1;

FIG. 4 is a front elevation view, of the second portion of the apparatus illustrated in FIG. 3;

FIG. 5 is a side elevation view, of the first portion engaged with the second portion of the apparatus illustrated in FIG. 3.

### DETAILED DESCRIPTION OF THE PREFERRED EMBODIMENT

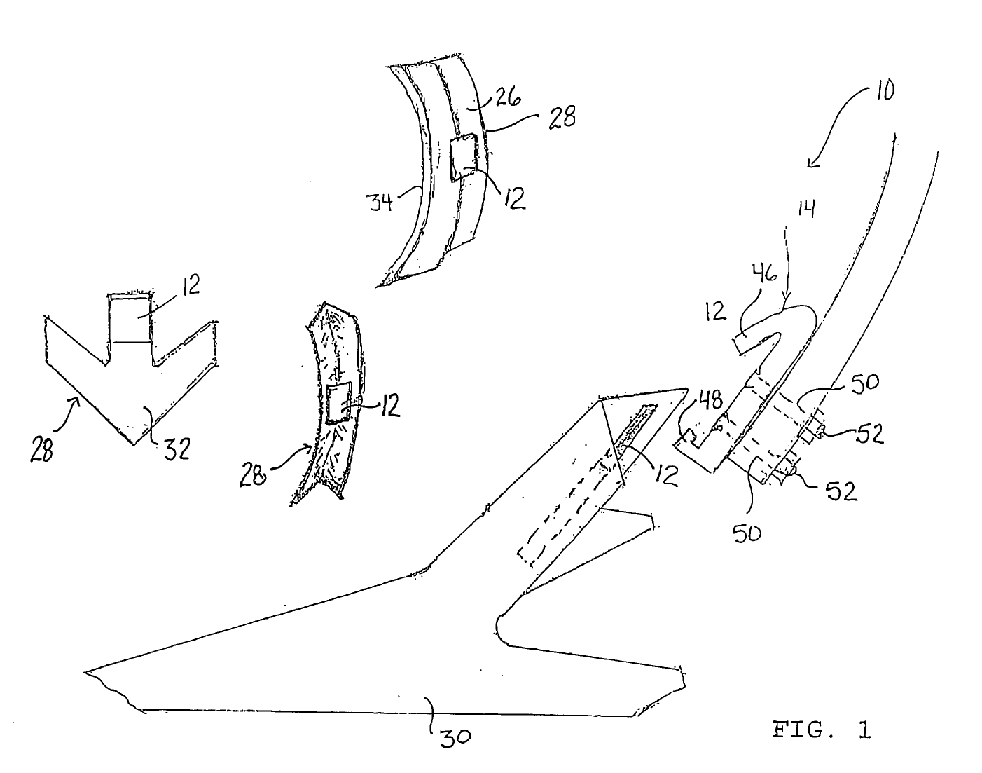

The preferred embodiment, an apparatus for detachably securing tool attachments to a cultivator generally identified by reference numeral 10, will now be described with reference to FIGS. 1 through 5.

Structure and Relationship of Parts:

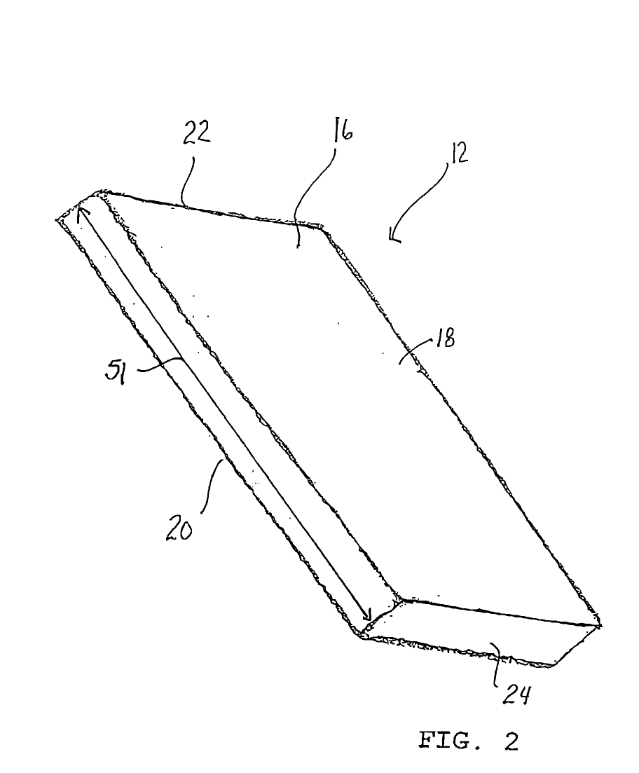

Referring to FIG. 1, there is illustrated an apparatus 10 for detachably securing tool attachments to a cultivator which includes a first portion 12 and a second portion 14. Referring to FIG. 2, first portion 12 has a planer mounting body 16 with a first face 18, a second face 20, a first peripheral end 22 and a second peripheral end 24. Referring to FIG. 1, planer body 16 is rectangular in shape and is welded to a backside surface 26 of a tool attachment 28 such as a sweep 30, spike 32, furrower 34 or similar cultivation tool.

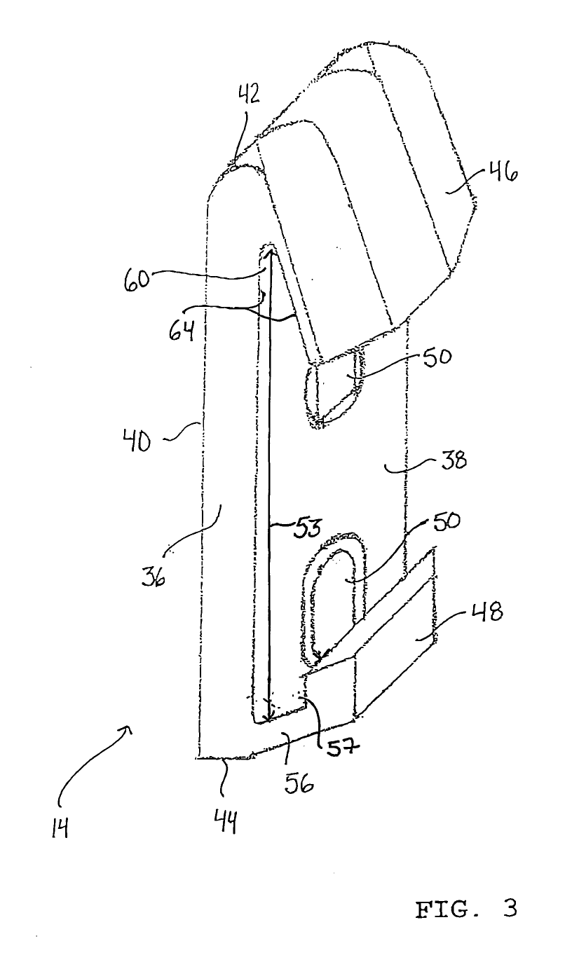

Referring to FIG. 3, second portion 14 has an elongate body 36 having a first face 38, a second face 40, a first end 42, and a second end 44. An upper retaining member 46 is provided at first end 42, and a lower retaining member 48 is provided at second end 44. Referring to FIG. 1, elongate body 36 has two apertures 50 adapted to received fastening bolts 52 for mounting second portion 14 to a shank 54 of a cultivator (not illustrated).

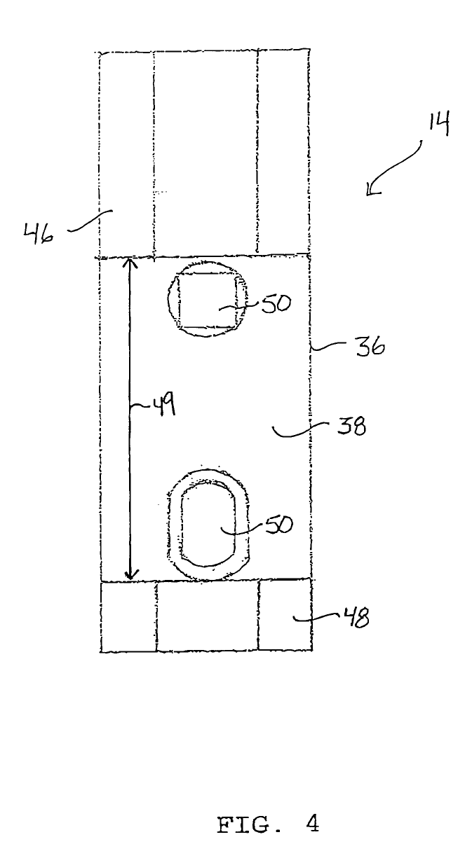

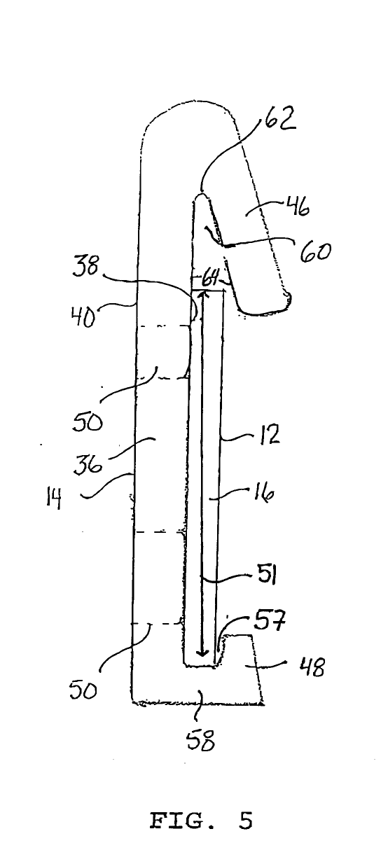

Referring to FIG. 5, upper retaining member 46 is angled outward from first face 38 adjacent first end 42 and extends toward second end 44 while lower retaining member 48 is angled outward from first face 38 adjacent second end 44 and extends toward first end 42, such that upon sliding engagement of first portion 12 with second portion 14, first end 22 of planer body 16 is positioned between upper retaining member 46 and first face 38 of elongate body 36, and second end 24 of planer body 16 is positioned between lower retaining member 48 and first face 38 of elongate body 36 to detachably secure tool attachment 28 to shank 54 illustrated in FIG. 1. Referring to FIG. 4, lower retaining member 48 has a shorter length than upper retaining member 46. Referring to FIG. 5, in the illustrated embodiment, lower retaining member 48 includes an extension 56 which extends lower retaining member 48 in a substantially perpendicular direction outward from first face 38 of elongate body 36 to create a bottom channel 57 illustrated in FIG. 3. Referring to FIG. 5, upper retaining member 26 is angled to create a wedge shaped top channel 60 with an apex 62 and converging side walls 64. Referring to FIG. 4, a first distance 49 between upper retaining member 46 and lower retaining member 48 is less than a length 51 of planer body 16 illustrated in FIG. 5 and referring to FIG. 3, a second distance 53 between the extremities of bottom channel 57 and top channel 60 is greater than length 51 of planer body 16 illustrated in FIG. 5. Referring to FIG. 5, this enables planer body 16 to be removable from elongate body 36, by lifting planer body 16 deeper into top channel 60 until second peripheral end 24 can clear lower retaining member 48.

Operation:

The use and operation of apparatus for detachably securing tool attachments to a cultivator 10 will now be described with reference to FIGS. 1 through 5. Referring to FIG. 1, in order to use apparatus 10, tool attachment 28 such as sweep 30, spike 32 or furrower 34 is provided. Shank 54 of a cultivator is also provided. Apparatus 10, as described above, is also provided. First portion 12 is mounted to backside surface 26 of tool attachment 28 by welding while second portion 14 is bolted by fastener bolts 52 to shank 54.

Referring to FIG. 5, first portion 12 is slidably engaged with second portion 14 such that first end 22 of planer body 16 is positioned between upper retaining member 46 and first face 38 of elongate body 36 of second portion 14, and second end 24 of planer body 16 is positioned between lower retaining member 48 and first face 38 of elongate body 36 of second portion 14 to detachably secure tool attachment 28 to shank 54 illustrated in FIG. 1.

Referring to FIG. 5, to slideably engage first portion 12 with second portion 14, first end 22 of planer body 16 is inserted between upper retaining member 46 and first face 38 of elongate body 36 of second portion 14 and pushed up until second end 24 of planer body 16 clears lower retaining member 48. Upper retaining member 46 limits upward movement of planer body 16. Second end 24 of planer body 16 can then be slid down between lower retaining member 48 and first face 38 of elongate body 36 of second portion 14. Lower retaining member 48 limits downward movement of planer body 16. The reverse action will disengage tool attachment 28 from shank 54.

Advantages:

Lower retaining member 48 at second end 44 of elongate body 36 of second portion 14 will prevent tool attachments 28 from falling off as a result of vibration or intense pressure occurrences. Apparatus 10 overcomes all the difficulties associated with bolting tool attachments 28 and other similar products to shanks 54 or similar frames.

As tool attachments 28 are not usually equipped with holes to bolt to shank 54, the welding of planer body 16 of first portion 12 to backside surface 26 of tool attachment 28 overcomes this difficulty. When planer body 16, which is welded onto tool attachments 28 such as spike 32 or sweep 30, is slid up under upper retaining member 46 and is held in place by the force of the soil pushing second portion 14 to shank 54, the resulting wedging effect secures second portion 14 from additional movements. When the plow is lifted out of the ground as it is moving, tool attachments 28 such as spike 32 or sweep 30 will be pushed down between lower retaining member 48 and first face 38 of elongate body 36. No matter how rough the terrain, tool attachment 28 can not fall off apparatus 10.

There is a special procedure for putting tool attachments 28 onto shank 54 using apparatus 10 and likewise for its removal. It is the design and arrangement of upper retaining member 46 and lower retaining member 48, and their alignment that prevents tool attachments 28 from falling off. Tool attachments 28 can't be removed by pulling them straight up or down or out perpendicular to shank 54. Apparatus 10 can universally work on all types of tool attachments 28 and changing from one type of tool attachment 28 to another only takes seconds.

By way of example, planer body 16 of first portion 12 is welded to backside surface 16 of sweep 30. Sweep 30 is then slid between upper retaining member 46 and first face 38 of elongate body 36 of second portion 14 and pushed up as high up as it can go into top channel 60 and then is pushed back against elongate body 36 of second portion 14. When cultivator is being pulled while not in the ground, sweep 30 is in such a position that second end 24 of planer body 16 is resting between lower retaining member 48 and first face 38 of elongate body 36 of second portion 14 in lower channel 57. Lower retaining member 48 prevents sweep 30 from falling off shank 54 as lower retaining member 48 serves to hold it in place. As cultivator is being pulled ahead and is lowered to start cultivating, the down and forward movement of sweep 30 on shank 54 forces first end 22 of planer body 16 on sweep 30 between upper retaining member 46 and first face 38 of elongate body 36 of second portion 14 to create a wedging effect in upper channel 60. When cultivating stops and shank 54 is lifted, and sweep 30 is pulled out of the ground, planer body 16 moves down and rests between lower retaining member 48 and first face 38 of elongate body 36 of second portion 14 in lower channel 57. Distance 49 between upper retaining member 46 and lower retaining member 48 is such that planer body 16 can only be disengaged from elongate body 36 with the appropriate action. Planer body 16 can not disengage from elongate body 36 out by pulling it perpendicular to elongate body 36. Planer body 16 must be pushed up, then pulled down and out to clear lower retaining member 48 of elongate body 36. This is the only way to engage or disengage first portion 12 and second portion 14.

Apparatus 10 provides an opportunity for changing and interchanging of sweeps 30, spikes 32, and other tool attachments in a minimal amount of time. As no bolts are used to secure tool attachments 28 to shank 54, an operator is able to slide sweep 30, spike 32 or other desired tool attachment 28 onto second portion 14 that is bolted to shank 54 aand merely slide it off when a change to another tool attachment 28 is required. The labour saving enables operators to make necessary changes in the least amount of time, and therefore employ the appropriate tool attachment 28 for the each particular cultivation job. Tool attachments 28 such as sweeps 30 and spikes 32 will require that planer body 16 of first portion 12 is welded to backside surface 26 of tool attachment 28 instead of providing bolt holes for bolting it to shank 54. As elongate body 36 of second portion 14 is bolted to shank 54, tool attachments 28 are simply slid into place and slid off when a change of tool attachment 28 is required. The apparatus 10 prevents sweeps 30, spikes 32 and other tool attachments 28 from failing off shank 54. The elimination of any mounting holes on tool attachments 28 and the addition of planer body 16 that is welded to backside surface 26 of tool attachment 28 serves to strengthen tool attachment 28 and reduce breakage.

The universality of the apparatus 10 is that it works for all soil cultivating tool attachments 28. It eliminates the laborious efforts in replacing worn tool attachments 28 or switching from one type of tool attachment 28 to another. An example is removing sweeps 30 after spring work and bolting on spikes 32 for the fall work. No hammers, or special equipment is required to knock tool attachment 28 off of shank 54. Furthermore, there are no special pins employed which tend to break or otherwise get lost. Apparatus 10 can be adapted for use with existing traditional attachment tools 28 without the need to create special designs of tool attachments 28. Apparatus 10 eliminates the problem of tool attachments 28 failing off and being left in the field where they can be run over resulting in a flat tires or other types of damage. Apparatus 10 can be manufactured in a variety of sizes and the same principles of its design make it applicable to a variety of different industries.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive Property or privilege is claimed are defined as follows:

1. An apparatus for detachably securing tool attachments to a cultivator, comprising:
a first portion and a second portion;
the first portion having a planer body having a first face, a second face, a first end and a second end;
means for securing the planer body to a surface of a tool attachment;
the second portion having an elongate body having a first face, a second face, a first end, and a second end, an upper retaining member is provided at the first end, and a lower retaining member is provided at the second end;
means for securing the second portion a surface of a shank of a cultivator;
the upper retaining member being angled outward from the first face adjacent the first end and toward the second end and the lower retaining member being angled outward from the first face adjacent the second end and toward the first end, such that upon sliding engagement of the first portion with the second portion, the first end of the planer body is positioned between the upper retaining member and the first face, and the second end of the planer body is positioned between the lower retaining member and the first face of the second portion to detachably secure the tool attachment to the shank of a cultivator.

2. The apparatus of claim 1, wherein the means for securing the plate to the tool attachment is by welding.

3. The apparatus of claim 1, wherein the means for securing the second portion to the shank of the cultivator is a bolt fastener.

4. The apparatus of claim 1, wherein the planer body has a length that is less than a length of the elongate body.

5. The apparatus of claim 1, wherein the planer body is in the shape of a rectangle.

6. A method of detachably securing tool attachments to a cultivator, comprising the steps of:
providing a tool attachment;
providing a cultivator with a shank;
providing an apparatus having a first portion and a second portion, the first portion being a planer body having a first face, a second face, a first end and a second end, the second portion being an elongate body having a first face, a second face, a first end, and a second end, an upper retaining member is provided at the first end, and a lower retaining member is provided at the second end, the upper retaining member being angled outward from the first face adjacent the first end and toward the second end, the lower retaining member being angled outward from the first face adjacent the second end and toward the first end;
mounting the first portion to the tool attachment;
mounting the second portion to the shank of the cultivator;
slidably engaging the first portion with the second portion such that the first end of the planer body is positioned between the upper retaining member and the first face and the second end of the planer body is positioned between the lower retaining member and the first face of the second portion to detachably secure the tool attachment to the shank of a cultivator.

7. The method of claim 6, wherein the first portion is mounted to the tool attachment by welding.

8. The method of claim 6, wherein the second portion is mounted to the shank of the cultivator by means of a bolt fastener.

9. The method of claim 6, wherein the planer body has a length that is less than a length of the elongate body.

10. The method of claim 6, wherein the planer body is in the shape of a rectangle

11. In combination:
a cultivation tool having secured to it a mounting plate having a top peripheral edge and a bottom peripheral edge; and
a mounting having a plate receiving body with a top and a bottom, the bottom having a bottom retainer with a bottom channel adapted to receive the bottom peripheral edge of the mounting plate and limit downward movement of the mounting plate, the top having a top retainer with a top channel adapted to receive the top peripheral edge of the mounting plate and limit upward movement of the mount plate, a first distance between the top retainer and the bottom retainer being less than a length of the mounting plate and second distance between respective extremities of the bottom channel and the top channel being greater than the length of the mounting plate, such that the mounting plate is removable from the mounting by lifting the mounting plate deeper into the top channel until the bottom peripheral edge of the mounting plate can clear the bottom retainer.

12. The combination as defined in claim 11, wherein the top channel is wedge shaped with an apex at its extremity and converging side walls.
